(19) United States
(12) Patent Application Publication
(10) Pub. No.: US 2026/0075212 A1
(43) Pub. Date: Mar. 12, 2026

(54) LEARNING-BASED HARD RATE CONTROL MECHANISM FOR POINT CLOUD COMPRESSION

(71) Applicant: InterDigital VC Holdings, Inc., Wilmington, DE (US)

(72) Inventors: Muhammad Asad Lodhi, Highland Park, NJ (US); Jiahao Pang, Plainsboro, NJ (US); Junghyun Ahn, New York, NY (US); Dong Tian, Boxborough, MA (US)

(21) Appl. No.: 18/830,336

(22) Filed: Sep. 10, 2024

(51) Int. Cl. H04N 19/146; H04N 19/136; H04N 19/30; H04N 19/42

(52) U.S. Cl. CPC H04N 19/146; H04N 19/136; H04N 19/30; H04N 19/42

(57) ABSTRACT

Some embodiments of a method may include: obtaining a bitstream and an already-decoded set of coordinates; generating a feature map by using the already-decoded set of coordinates; using a neural network to produce one or more predicted displacements from each feature in the feature map; and adding the one or more predicted displacements to the already decoded set of coordinates to obtain a final reconstruction. Some embodiments of a method may include: obtaining a plurality of per-point residuals between an original and a downscaled point cloud; using a neural network to obtain a feature for each residual; pooling the features according to a geometry of the downscaled point cloud; and encoding the pooled features into a bitstream.

### INCORPORATION BY REFERENCE

The present application incorporates by reference in their entirety the following applications: U.S. Non-Provisional patent application Ser. No. 18/814,400, entitled “A Learning-Based Point Cloud Geometry Compression Framework” and filed Aug. 23, 2024 (“'400 application”); U.S. Non-Provisional patent application Ser. No. 18/784,466, entitled “End-to-End Learning-Based Dynamic Point Cloud Coding Framework” and filed Jul. 25, 2024 (“'466 application”); U.S. Non-Provisional patent application Ser. No. 18/679,144, entitled “An End-to-End Learning-Based Point Cloud Coding Framework” and filed May 30, 2024 (“'144 application”); U.S. Non-Provisional patent application Ser. No. 18/669,079, entitled “Model Sharing for Point Cloud Compression” and filed May 20, 2024 (“'079 application”); and U.S. Non-Provisional patent application Ser. No. 18/654,987, entitled “Rate Control for Point Cloud Coding with a Hyperprior Model” and filed May 3, 2024 (“'987 application”).

### BACKGROUND

The present application is related to the field of point cloud compression and processing.

### SUMMARY

A first example method in accordance with some embodiments may include: obtaining a bitstream and an already-decoded set of coordinates; generating a feature map by using the already-decoded set of coordinates; using a neural network to produce one or more predicted displacements from each feature in the feature map; and adding the one or more predicted displacements to the already decoded set of coordinates to obtain a final reconstruction.

Some embodiments of the first example method may further include decoding the bitstream to obtain a set of features, wherein generating the feature map further uses the set of features.

For some embodiments of the first example method, generating the feature map further uses the bitstream.

Some embodiments of the first example method may further include updating the feature map.

For some embodiments of the first example method, updating the feature map includes: passing the bitstream through a feature decoder to generate a feature decoder output; passing the feature decoder output through a series of upsampling neural network layers; pruning an output of the upsampling neural network layers; and updating the feature map based on the pruned output of the upsampling neural network layers.

For some embodiments of the first example method, the already-decoded set of coordinates is an already-decoded set of lossy coordinates.

Some embodiments of the first example method may further include: obtaining a rate control bitstream; and passing the already-decoded set of coordinates and the rate control bitstream through a rate control decoder to produce the one or more predicted displacements.

For some embodiments of the first example method, obtaining the rate control bitstream includes: obtaining an original set of coordinates; and passing the already-decoded set of coordinates and the original set of coordinates through a rate control encoder to generate a rate control bitstream.

Some embodiments of the first example method may further include passing the already-decoded set of coordinates and the bitstream through a rate control decoder to produce the one or more predicted displacements.

For some embodiments of the first example method, passing the already-decoded set of coordinates and the bitstream through the rate control decoder uses the neural network to produce the one or more predicted displacements.

A second example method in accordance with some embodiments may include: obtaining a plurality of per-point residuals between an original and a downscaled point cloud; using a neural network to obtain a feature for each residual; pooling the features according to a geometry of the downscaled point cloud; and encoding the pooled features into a bitstream.

Some embodiments of the second example method may further include: obtaining a plurality of coordinates associated with the original point cloud; obtaining a plurality of coordinates associated with the downscaled point cloud; and determining the plurality of per-point residuals as a difference between the plurality of respective coordinates associated with the original point cloud and the plurality of respective coordinates associated with the downscaled point cloud.

For some embodiments of the second example method, pooling the features according to the geometry of the downscaled point cloud includes pooling the features according to the coordinates of the downscaled point cloud.

Some embodiments of the second example method may further include generating a rate control bitstream.

For some embodiments of the second example method, generating a rate control bitstream includes passing a plurality of coordinates associated with the original point cloud and a plurality of coordinates associated with the downscaled point cloud through a rate control encoder to generate the rate control bitstream.

Some embodiments of the second example method may further include communicating to a device a plurality of coordinates associated with the original point cloud.

Some embodiments of the second example method may further include passing the features through a series of downsampling neural network layers.

Some embodiments of the second example method may further include performing a fractional scaling of the plurality of coordinates associated with the original point cloud.

For some embodiments of the second example method, performing the fractional scaling includes: passing a plurality of coordinates associated with the original point cloud through a fractional scaling block to generate a plurality of scaled coordinates associated with a scaled point cloud; and encoding the plurality of scaled coordinates.

An example apparatus in accordance with some embodiments may include: a processor; and a memory storing instructions operative, when executed by the processor, to cause the apparatus to: obtain a bitstream and an already-decoded set of coordinates; generate a feature map by using the already-decoded set of coordinates; use a neural network to produce one or more predicted displacements from each feature in the feature map; and add the one or more predicted displacements to the already decoded set of coordinates to obtain a final reconstruction.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example set of interfaces for a system according to some embodiments.

FIG. 1B is a schematic side view illustrating an example waveguide display that may be used with extended reality (XR) applications according to some embodiments.

FIG. 1C is a schematic side view illustrating an example alternative display type that may be used with extended reality applications according to some embodiments.

FIG. 1D is a schematic side view illustrating an example alternative display type that may be used with extended reality applications according to some embodiments.

FIG. 2 is a process diagram illustrating an example of a typical hard rate control with fractional scaling according to some embodiments.

FIG. 3 is a process diagram illustrating an example hard rate control with fractional scaling according to some embodiments.

FIG. 4 is a process diagram illustrating an example hard rate control with fractional scaling and skip according to some embodiments.

FIG. 5 is a process diagram illustrating an example hard rate control with fractional scaling and skip according to some embodiments.

FIG. 6 is a process diagram illustrating an example point-based encoder according to some embodiments.

FIG. 7 is a process diagram illustrating an example point-based decoder according to some embodiments.

FIG. 8 is a process diagram illustrating an example modified point-based decoder according to some embodiments.

FIG. 9 is a flowchart illustrating an example encoding process according to some embodiments.

FIG. 10 is a flowchart illustrating an example decoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

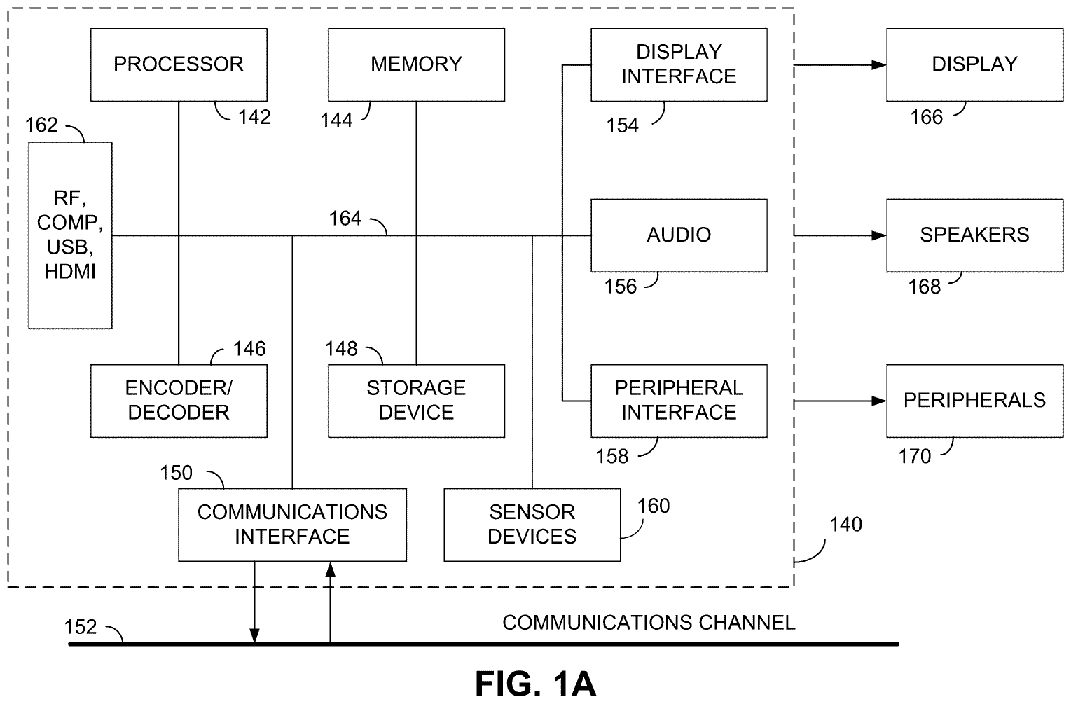

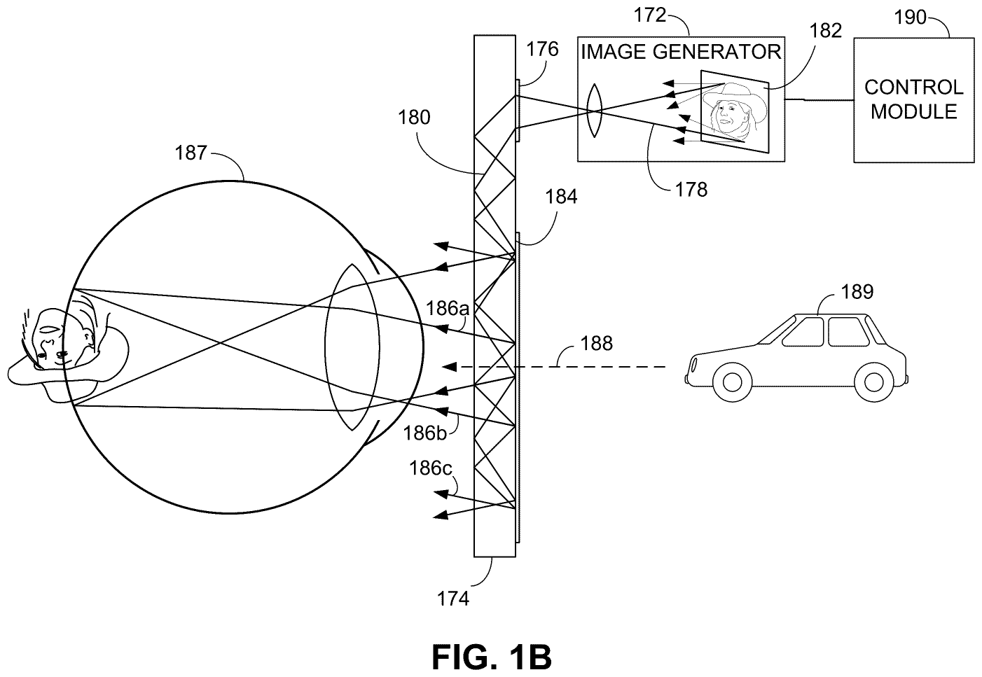

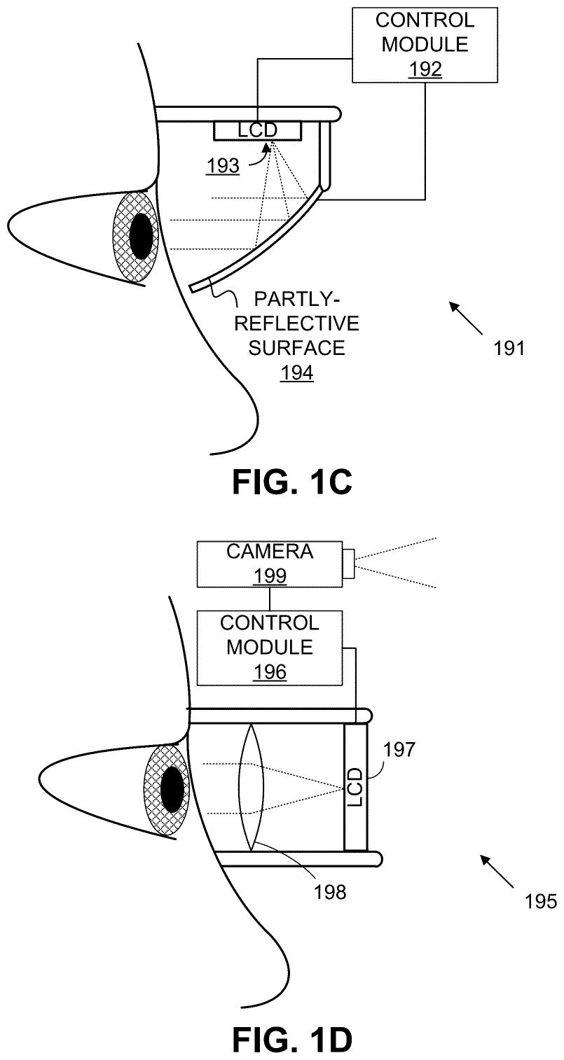

FIG. 1A is a system diagram illustrating an example set of interfaces for a system according to some embodiments. An extended reality display device, together with its control electronics, may be implemented using a system such as the system of FIG. 1A. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1A, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

### Scene Description Framework for XR

In some embodiments, examples disclosed herein may be used in the domain of rendering of extended reality scene description and extended reality rendering. For some embodiments, for example, the present application may be applied in the context of the formatting and the playing of extended reality applications when rendered on end-user devices such as mobile devices or Head-Mounted Displays (HMD). For some example embodiments, glTF material may be rendered in a 3D environment that is rendered through a 2D screen. The examples presented herein in accordance with some embodiments are not limited to XR applications.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology—Coded representation of immersive media—Part 14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

FIG. 1B is a schematic side view illustrating an example waveguide display that may be used with extended reality (XR) applications according to some embodiments. An image is projected by an image generator 172. The image generator 172 may use one or more of various techniques for projecting an image. For example, the image generator 172 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 182 generated by the image generator 172 is coupled into a waveguide 174 by a diffractive in-coupler 176. The in-coupler 176 diffracts the light representing the image 182 into one or more diffractive orders. For example, light ray 178, which is one of the light rays representing a portion of the bottom of the image, is diffracted by the in-coupler 176, and one of the diffracted orders 180 (e.g. the second order) is at an angle that is capable of being propagated through the waveguide 174 by total internal reflection. The image generator 172 displays images as directed by a control module 190, which operates to render image data, video data, point cloud data, or other displayable data.

At least a portion of the light 180 that has been coupled into the waveguide 174 by the diffractive in-coupler 176 is coupled out of the waveguide by a diffractive out-coupler 184. At least some of the light coupled out of the waveguide 174 replicates the incident angle of light coupled into the waveguide. For example, in the illustration, out-coupled light rays 186a, 186b, and 186c replicate the angle of the in-coupled light ray 178. Because light exiting the out-coupler replicates the directions of light that entered the in-coupler, the waveguide substantially replicates the original image 182. A user's eye 187 can focus on the replicated image.

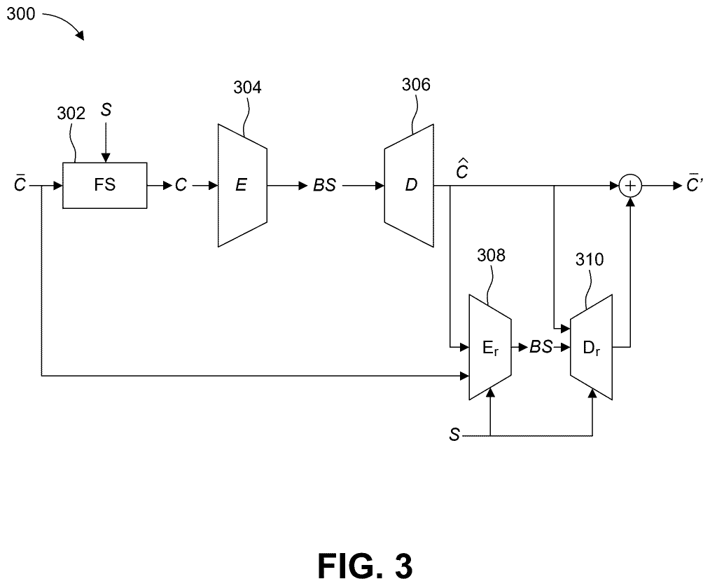

In the example of FIG. 1B, the out-coupler 184 out-couples only a portion of the light with each reflection allowing a single input beam (such as beam 178) to generate multiple parallel output beams (such as beams 186a, 186b, and 186c). In this way, at least some of the light originating from each portion of the image is likely to reach the user's eye even if the eye is not perfectly aligned with the center of the out-coupler. For example, if the eye 187 were to move downward, beam 186c may enter the eye even if beams 186a and 186b do not, so the user can still perceive the bottom of the image 182 despite the shift in position. The out-coupler 184 thus operates in part as an exit pupil expander in the vertical direction. The waveguide may also include one or more additional exit pupil expanders (not shown in FIG. 3A) to expand the exit pupil in the horizontal direction.

In some embodiments, the waveguide 174 is at least partly transparent with respect to light originating outside the waveguide display. For example, at least some of the light 188 from real-world objects (such as object 189) traverses the waveguide 174, allowing the user to see the real-world objects while using the waveguide display. As light 188 from real-world objects also goes through the diffraction grating 184, there will be multiple diffraction orders and hence multiple images. To minimize the visibility of multiple images, it is desirable for the diffraction order zero (no deviation by 184) to have a great diffraction efficiency for light 188 and order zero, while higher diffraction orders are lower in energy. Thus, in addition to expanding and out-coupling the virtual image, the out-coupler 184 is preferably configured to let through the zero order of the real image. In such embodiments, images displayed by the waveguide display may appear to be superimposed on the real world.

FIG. 1C is a schematic side view illustrating an example alternative display type that may be used with extended reality applications according to some embodiments. In an XR head-mounted display device 191, a control module 192 controls a display 193, which may be an LCD, to display an image. The head-mounted display includes a partly-reflective surface 194 that reflects (and in some embodiments, both reflects and focuses) the image displayed on the LCD to make the image visible to the user. The partly-reflective surface 194 also allows the passage of at least some exterior light, permitting the user to see their surroundings.

FIG. 1D is a schematic side view illustrating an example alternative display type that may be used with extended reality applications according to some embodiments. In an XR head-mounted display device 195, a control module 196 controls a display 197, which may be an LCD, to display an image. The image is focused by one or more lenses of display optics 198 to make the image visible to the user. In the example of FIG. 1D, exterior light does not reach the user's eyes directly. However, in some such embodiments, an exterior camera 199 may be used to capture images of the exterior environment and display such images on the display 197 together with any virtual content that may also be displayed.

The embodiments described herein are not limited to any particular type or structure of XR display device.

A User Equipment (UE) may correspond to any eXtended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

The field of point cloud compression and processing aims to develop tools for compression, analysis, interpolation, representation and understanding of input signals, such as point clouds. This application extends the technologies described in the '144, '466, and '400 applications with hard rate control mechanisms.

Point cloud data is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020, and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when the storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z) . The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer as opposed to standard TV in which the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

### General Challenges

3D point cloud data include discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds may be classified into two categories: geometry coding and attribute coding.

Examples of existing learning-based point cloud geometry compression techniques are deep octree coding and end-to-end feature-based geometry coding. With deep octree coding, neural network-based models are utilized to estimate the occupancy probabilities. Such estimated probabilities are then used to help the arithmetic coder to encode or decode a binary flag indicating whether a child octree voxel is occupied or empty.

Point cloud compression is a problem in many practical applications, such as autonomous driving, and AR/VR. This application relates to point cloud geometry compression based on deep learning and sparse tensor processing. Existing rate control mechanisms within the point cloud compression domain are understood to achieve either soft rate control with limited range or naïve hard rate control with aliasing artifacts. This application discusses a learning-based hard rate control approach for a wider rate range while minimizing artifacts.

This application discusses an alternative to soft rate control mechanisms present in other applications mentioned earlier and existing naïve hard control mechanisms. The existing hard rate control is discussed first.

### Soft Vs Hard Rate Control

Soft rate control refers to a mechanism of rate control in which the input to a neural network is fixed (having fixed precision/bit depth), but the network learns to change the output quality and the corresponding rate required by changing a user-provided parameter. This method is described in the '400 application as style control deployed for fine grain rate control. Since the intention is to achieve fine grain rate control, the resulting rate range may be limited.

Hard rate control, on the other hand, changes the input to a neural network itself. Such a change may be done by filtering the input to remove high frequency information, by downsampling the input, or by reducing the precision of the input data. For some embodiments, use of a scaling factor s, which is discussed later, is another example of a hard rate control. For example, making s an integer valued inverse power of 2 (equal to 2⁻ⁿ) may reduce the precision of the input by n bits. Since a hard rate control mechanism fundamentally changes the input, such a mechanism may achieve a much larger rate range while at the same time being prone to introducing artifacts in the input data.

### (Naïve) Hard Rate Control

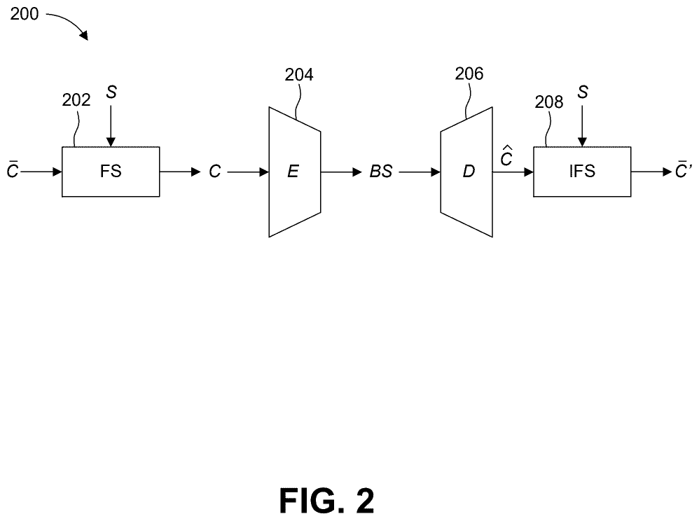

FIG. 2 is a process diagram illustrating an example of a typical hard rate control with fractional scaling according to some embodiments. An example naïve hard rate control may be achieved via fractional scaling of the input data. FIG. 2 shows an example process 200 of this approach in an overall point cloud compression system. On the encoder side of such a process 200, a scaling factor s≤1 may be used to scale the geometry coordinates of the input point cloud followed by rounding the coordinates to the nearest integer. This operation is depicted by the fractional scaling (FS) block 202. On the decoder side, the inverse fractional scaling (IFS) block 208 is placed after the decoder reconstruction 206 to reverse the effects of coordinate scaling. The encoder 204 and decoder 206 pair may be lossy or lossless.

For some embodiments, an already-decoded set of coordinates may be an already-decoded set of lossless coordinates. For some embodiments, an already-decoded set of coordinates may be an already-decoded set of lossy coordinates.

This approach may effectively reduce the bit depth of the input and hence the bitstream size but may introduce aliasing artifacts, well known in the signal processing community. Moreover, there is also a loss of points (due to rounding of the scaled coordinates to integers) which cannot be recovered on the decoder side. Filtering the geometry coordinates first with a smoothing (low pass) filter prior to the scaling may be a way to reduce the artifacts, but this approach cannot fully resolve these problems.

This application discusses a learning-based hard rate control mechanism, which may alleviate the problems of aliasing artifacts and loss of points prevalent in naïve hard rate control via fractional scaling. For some embodiments, an additional bitstream or an already-available bitstream from the main encoding/decoding pipeline may be used to achieve learning-based rate control.

### Hard Rate Control Mechanism

FIG. 3 is a process diagram illustrating an example hard rate control with fractional scaling according to some embodiments. In FIG. 3, a hard rate control mechanism is shown in an overall point cloud compression system 300. As may be seen, the FS block 302 on the encoder side is still there, but the decoder side has changed and does not use the IFS block. Instead, an additional encoding/decoding pair (Eᵣ/Dᵣ) is used, which may help achieve learning-based rate control.

The original input coordinates C̅ are passed through the FS block 302 to obtain new coordinates C, which are sent to the main pipeline with the encoder 304 and decoder 306. After the main encoding/decoding pipeline decodes the coordinates, these decoded coordinates are inputted into the rate control encoder Eᵣ 308, along with the original input coordinates C̅. The rate control encoder Eᵣ 308 uses the original and decoded coordinates, along with the scaling factor s, to encode some information in a second bitstream. The rate control decoder Dᵣ 310 uses this second bitstream to produce new points on top of the already decoded points from the main encoding/decoding pipeline. The use of the second bitstream may be thought of as a sequential encoding and decoding mechanism. The second bitstream provides more details on top of the first bitstream.

The training of the pipeline may either be done simultaneously with the main encoding/decoding pipeline, or separately after the main pipeline has been trained. Training is discussed later.

### Rate Control with Skip

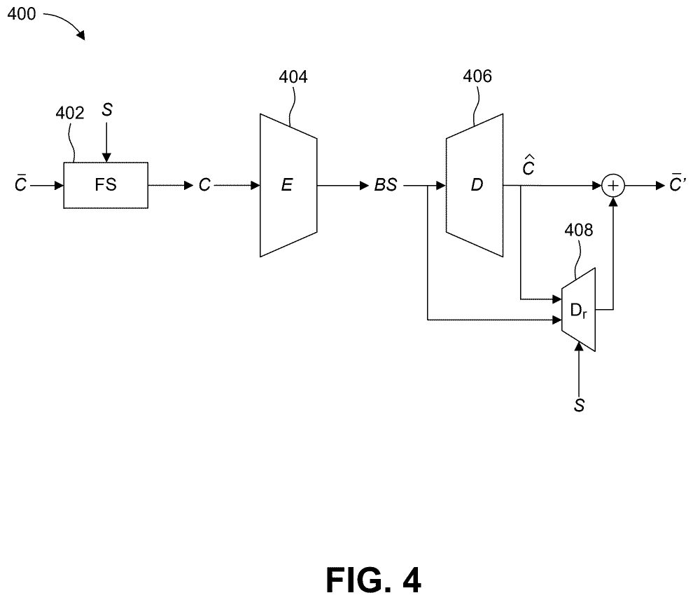

FIG. 4 is a process diagram illustrating an example hard rate control with fractional scaling and skip according to some embodiments. For some embodiments, the rate control mechanism does not require a separate bitstream but uses the bitstream from the main encoding/decoding pipeline to produce predicted displacements.

In the overall point cloud compression system 400, the original input coordinates C̅ are passed through the FS block 402 to obtain new coordinates C, which are sent to the main pipeline with the encoder 404 and decoder 406. After the main encoding/decoding pipeline decodes the coordinates, these decoded coordinates Ĉ are inputted into the rate control decoder Dᵣ 408, along with the encoded bitstream (BS). The rate control decoder Dᵣ 408 uses the encoded bitstream (BS) and the decoded coordinates, along with the scaling factor s, to produce new points on top of the already decoded points from the main encoding/decoding pipeline.

### Rate Control with Skip

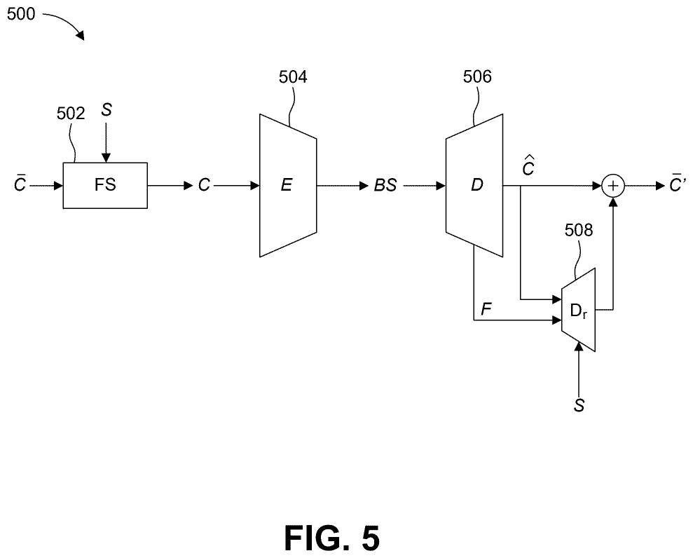

FIG. 5 is a process diagram illustrating an example hard rate control with fractional scaling and skip according to some embodiments. Another way to perform rate control with skip is by not using the bitstream at all, but instead using the decoded geometry Ĉ and its associated feature map F from the main encoding/decoding pipeline directly, as shown in FIG. 5.

In the process 500 of FIG. 5, the original input coordinates C̅ are passed through the FS block 502 to obtain new coordinates C, which are sent to the main encoder 504. The output bitstream BS goes to the main decoder 506. After the main decoder 506 decodes the coordinates, these decoded coordinates Ĉ are inputted into the rate control decoder Dᵣ 508, along with the associated feature map F. The rate control decoder Dᵣ 508 uses the decoded coordinates and the associated feature map F, along with the scaling factor s, to produce new points on top of the already decoded points from the main encoding/decoding pipeline.

### Point-based Rate Control Encoder

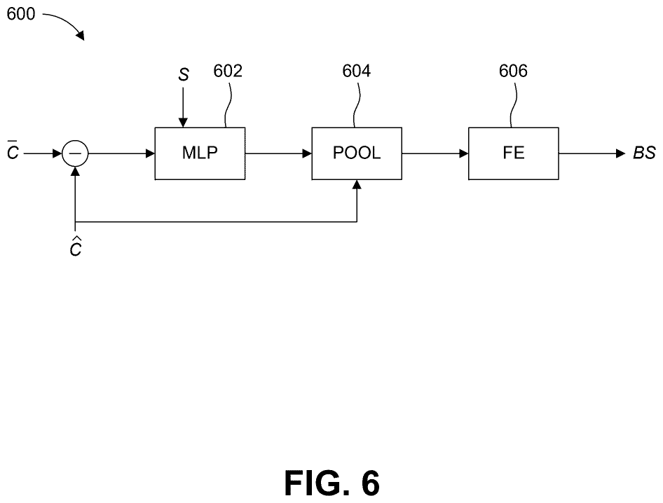

FIG. 6 is a process diagram illustrating an example point-based encoder according to some embodiments. The diagram of the rate control encoder shown in FIG. 6 is a point-based pipeline that first computes the difference between each point in the original point cloud C̅ from its scaled version in the reconstructed scaled point cloud Ĉ. The difference is sent to an MLP block 602, which converts each difference into a feature vector, thus making a feature map living on the original coordinates. This feature map is then pooled via a pool process 604. All features of all points are scaled to the same scaled point and pooled into one feature through a pooling operation 604, which may include max pooling and average pooling, among other processes. The resulting feature map resides on the reconstructed scaled coordinates Ĉ and is encoded into a bitstream using a feature encoder (FE) block 606. The FE block 606 is discussed above.

### Point-Based Rate Control Decoder

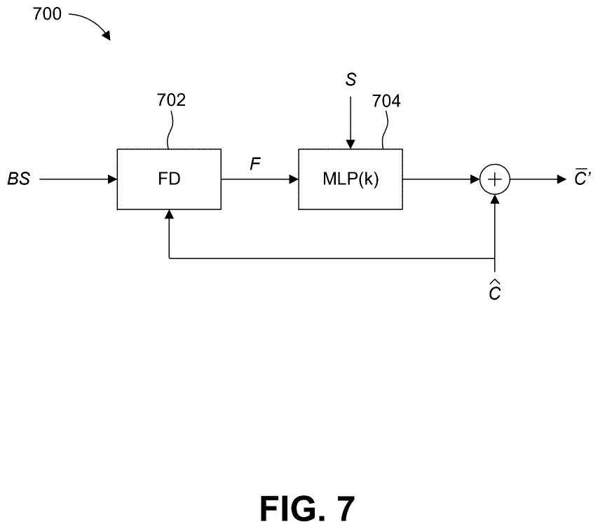

FIG. 7 is a process diagram illustrating an example point-based decoder according to some embodiments. Looking at FIG. 7, the feature decoder (FD) may be skipped and flow may go directly to the MLP block and the rest of the pipeline. The rate control in this case becomes a post processing procedure, and should be trained separately from the main encoding/decoding pipeline.

In FIG. 7, the example rate control decoder 700 is a point-based pipeline that decodes a feature map F from the bitstream using the feature decoder (FD) 702. The feature map, along with the scaling factor s, goes through an MLP block 704, which converts the feature map into predicted displacements. The number of displacements outputted per point in Ĉ is controlled by a user-specified upsampling factor k. These predicted displacements are then added on top of the already decoded coordinates Ĉ from the main encoding/decoding pipeline. Thus, the decoder is able to either (1) improve the quality of the earlier decoded geometry (if k=1), or (2) upsample and improve the quality simultaneously (if k>1). The FD block 702 is discussed above.

For some embodiments, if the architecture of FIG. 5 is used with the architecture of FIG. 7, the FD block 702 of FIG. 7 is not used, and the already decoded coordinates Ĉ are inputted only into the addition (“+”) block.

### Rate Control with Skip

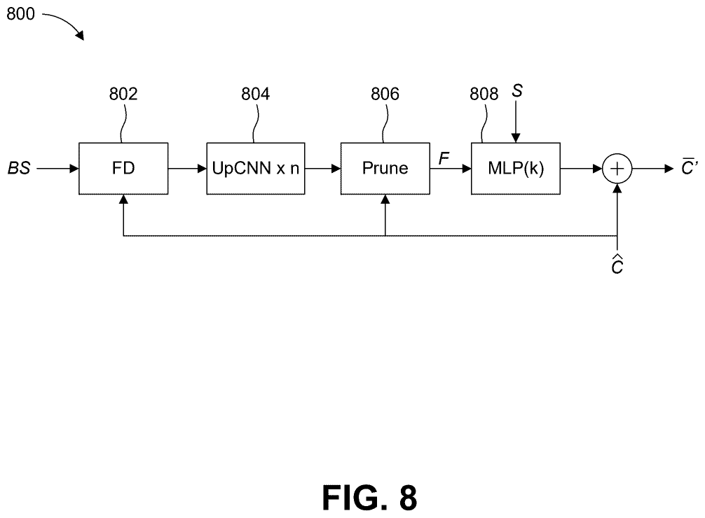

FIG. 8 is a process diagram illustrating an example modified point-based decoder according to some embodiments. For some embodiments, the rate control mechanism does not require a separate bitstream but uses the bitstream from the main encoding/decoding pipeline to produce predicted displacements. The overall pipeline in shown in FIG. 4, while a modified rate control decoder design 800 is shown in FIG. 8. The bitstream BS is passed through a feature decoder (FD) 802.

The decoded feature map is first upsampled n times via an UpCNN×n block 804. The output is pruned via a prune process 806 to match the decoded geometry Ĉ. The upsampled and pruned feature map F is sent to the MLP 808 as before and the rest of the pipeline is the same as FIG. 7. For some embodiments, skipping a separate bitstream may help achieve lower bitrates while still providing results that are better than the naïve hard rate control method.

In another embodiment, the pipeline in FIG. 5, can be used in which case the feature map associated with Ĉ directly goes to the upsampling block 804, and the rest of the pipeline follows.

As mentioned before, the training of the pipeline may be done either simultaneously with the main encoding/decoding pipeline, or separately after the main pipeline has been trained.

### Training Strategy

Training is discussed with regard to the pipeline of FIG. 3. As pointed out earlier, this training may be performed in tandem with the main encoding/decoding pipeline or separately. First, the rate of the feature F (denoted by R) is computed. The distortion is also computed. In this case, the distortion is the chamfer distance loss between the predicted output coordinates and the ground-truth coordinates, denoted by D. The overall loss is given by L=D+λ·R, in which λ is the R-D tradeoff parameter. This loss is computed in addition to the loss of the main pipeline if joint training is being performed.

For training of the pipeline in FIG. 4 and FIG. 5, only the chamfer distance loss between the predicted output coordinates and the ground-truth coordinates is (additionally) computed since a separate bitstream is not used.

This application discusses a learning-based hard rate control mechanism, which may alleviate the problems of aliasing artifacts and loss of points prevalent to the naïve hard rate control via fractional scaling. Some embodiments use an additional bitstream or an already-available bitstream from the main encoding/decoding pipeline to achieve learning-based rate control.

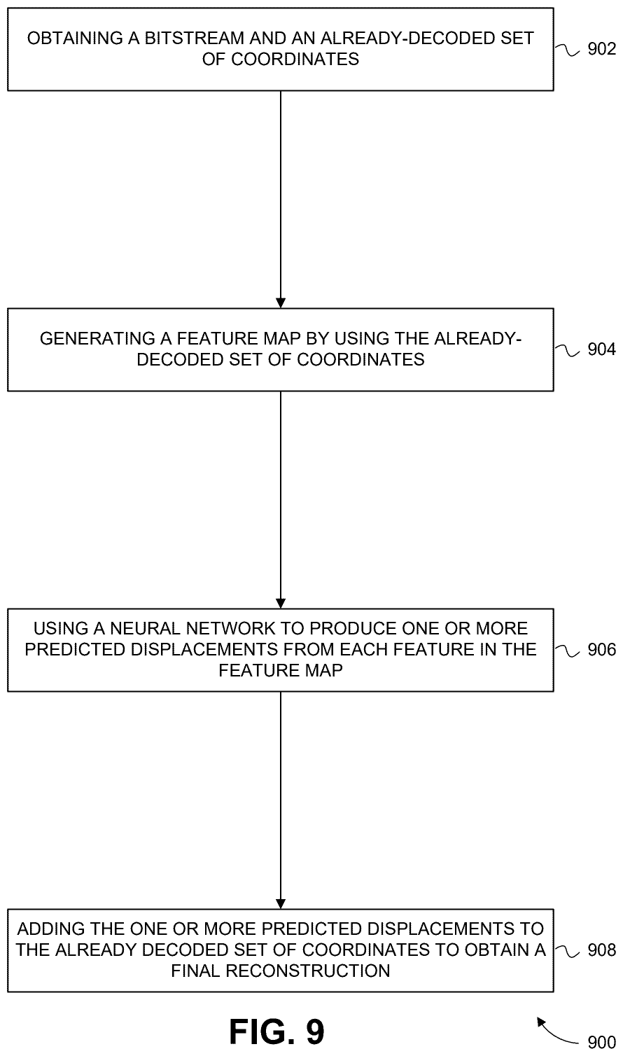

FIG. 9 is a flowchart illustrating an example encoding process according to some embodiments. For some embodiments, an example process 900 may include obtaining 902 a bitstream and an already-decoded set of coordinates. For some embodiments, the example process 900 may further include generating 904 a feature map by using the already-decoded set of coordinates. For some embodiments, the example process 900 may further include using 906 a neural network to produce one or more predicted displacements from each feature in the feature map. For some embodiments, the example process 900 may further include adding 908 the one or more predicted displacements to the already decoded set of coordinates to obtain a final reconstruction.

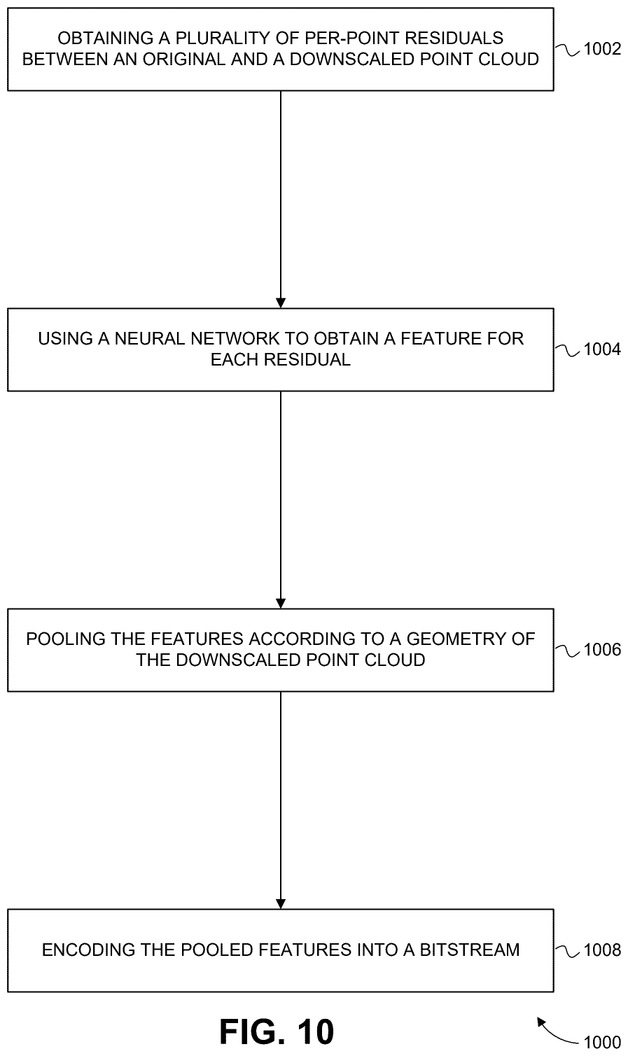

FIG. 10 is a flowchart illustrating an example decoding process according to some embodiments. For some embodiments, an example process 1000 may include obtaining 1002 a plurality of per-point residuals between an original and a downscaled point cloud. For some embodiments, the example process 1000 may further include using 1004 a neural network to obtain a feature for each residual. For some embodiments, the example process 1000 may further include pooling 1006 the features according to a geometry of the downscaled point cloud. For some embodiments, the example process 1000 may further include encoding 1008 the pooled features into a bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a bitstream and an already-decoded set of coordinates; generating a feature map by using the already-decoded set of coordinates; using a neural network to produce one or more predicted displacements from each feature in the feature map; and adding the one or more predicted displacements to the already decoded set of coordinates to obtain a final reconstruction.

Some embodiments of the first example method may further include decoding the bitstream to obtain a set of features, wherein generating the feature map further uses the set of features.

For some embodiments of the first example method, generating the feature map further uses the bitstream.

Some embodiments of the first example method may further include updating the feature map.

For some embodiments of the first example method, updating the feature map includes: passing the bitstream through a feature decoder to generate a feature decoder output; passing the feature decoder output through a series of upsampling neural network layers; pruning an output of the upsampling neural network layers; and updating the feature map based on the pruned output of the upsampling neural network layers.

For some embodiments of the first example method, the already-decoded set of coordinates is an already-decoded set of lossy coordinates.

Some embodiments of the first example method may further include: obtaining a rate control bitstream; and passing the already-decoded set of coordinates and the rate control bitstream through a rate control decoder to produce the one or more predicted displacements.

For some embodiments of the first example method, obtaining the rate control bitstream includes: obtaining an original set of coordinates; and passing the already-decoded set of coordinates and the original set of coordinates through a rate control encoder to generate a rate control bitstream.

Some embodiments of the first example method may further include passing the already-decoded set of coordinates and the bitstream through a rate control decoder to produce the one or more predicted displacements.

For some embodiments of the first example method, passing the already-decoded set of coordinates and the bitstream through the rate control decoder uses the neural network to produce the one or more predicted displacements.

A second example method in accordance with some embodiments may include: obtaining a plurality of per-point residuals between an original and a downscaled point cloud; using a neural network to obtain a feature for each residual; pooling the features according to a geometry of the downscaled point cloud; and encoding the pooled features into a bitstream.

Some embodiments of the second example method may further include: obtaining a plurality of coordinates associated with the original point cloud; obtaining a plurality of coordinates associated with the downscaled point cloud; and determining the plurality of per-point residuals as a difference between the plurality of respective coordinates associated with the original point cloud and the plurality of respective coordinates associated with the downscaled point cloud.

For some embodiments of the second example method, pooling the features according to the geometry of the downscaled point cloud includes pooling the features according to the coordinates of the downscaled point cloud.

Some embodiments of the second example method may further include generating a rate control bitstream.

For some embodiments of the second example method, generating a rate control bitstream includes passing a plurality of coordinates associated with the original point cloud and a plurality of coordinates associated with the downscaled point cloud through a rate control encoder to generate the rate control bitstream.

Some embodiments of the second example method may further include communicating to a device a plurality of coordinates associated with the original point cloud.

Some embodiments of the second example method may further include passing the features through a series of downsampling neural network layers.

Some embodiments of the second example method may further include performing a fractional scaling of the plurality of coordinates associated with the original point cloud.

For some embodiments of the second example method, performing the fractional scaling includes: passing a plurality of coordinates associated with the original point cloud through a fractional scaling block to generate a plurality of scaled coordinates associated with a scaled point cloud; and encoding the plurality of scaled coordinates.

An example apparatus in accordance with some embodiments may include: a processor; and a memory storing instructions operative, when executed by the processor, to cause the apparatus to: obtain a bitstream and an already-decoded set of coordinates; generate a feature map by using the already-decoded set of coordinates; use a neural network to produce one or more predicted displacements from each feature in the feature map; and add the one or more predicted displacements to the already decoded set of coordinates to obtain a final reconstruction.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, comprising:
obtaining a bitstream and an already-decoded set of coordinates;
generating a feature map by using the already-decoded set of coordinates;
using a neural network to produce one or more predicted displacements from each feature in the feature map; and
adding the one or more predicted displacements to the already decoded set of coordinates to obtain a final reconstruction.

2. The method of claim 1, further comprising:
decoding the bitstream to obtain a set of features,
wherein generating the feature map further uses the set of features.

3. The method of claim 1, wherein generating the feature map further uses the bitstream.

4. The method of claim 1, further comprising updating the feature map.

5. The method of claim 4, wherein updating the feature map comprises:
passing the bitstream through a feature decoder to generate a feature decoder output;
passing the feature decoder output through a series of upsampling neural network layers;
pruning an output of the upsampling neural network layers; and
updating the feature map based on the pruned output of the upsampling neural network layers.

6. The method of claim 1, wherein the already-decoded set of coordinates is an already-decoded set of lossy coordinates.

7. The method of claim 1, further comprising:
obtaining a rate control bitstream; and
passing the already-decoded set of coordinates and the rate control bitstream through a rate control decoder to produce the one or more predicted displacements.

8. The method of claim 7, wherein obtaining the rate control bitstream comprises:
obtaining an original set of coordinates; and
passing the already-decoded set of coordinates and the original set of coordinates through a rate control encoder to generate a rate control bitstream.

9. The method of claim 1, further comprising:
passing the already-decoded set of coordinates and the bitstream through a rate control decoder to produce the one or more predicted displacements.

10. The method of claim 9, wherein passing the already-decoded set of coordinates and the bitstream through the rate control decoder uses the neural network to produce the one or more predicted displacements.

11. A method, comprising:
obtaining a plurality of per-point residuals between an original and a downscaled point cloud;
using a neural network to obtain a feature for each residual;
pooling the features according to a geometry of the downscaled point cloud; and
encoding the pooled features into a bitstream.

12. The method of claim 11, further comprising:
obtaining a plurality of coordinates associated with the original point cloud;
obtaining a plurality of coordinates associated with the downscaled point cloud; and
determining the plurality of per-point residuals as a difference between the plurality of respective coordinates associated with the original point cloud and the plurality of respective coordinates associated with the downscaled point cloud.

13. The method of claim 11, wherein pooling the features according to the geometry of the downscaled point cloud comprises pooling the features according to the coordinates of the downscaled point cloud.

14. The method of claim 11, further comprising generating a rate control bitstream.

15. The method of claim 14, wherein generating a rate control bitstream comprises passing a plurality of coordinates associated with the original point cloud and a plurality of coordinates associated with the downscaled point cloud through a rate control encoder to generate the rate control bitstream.

16. The method of claim 11, further comprising communicating to a device a plurality of coordinates associated with the original point cloud.

17. The method of claim 11, further comprising passing the features through a series of downsampling neural network layers.

18. The method of claim 11, further comprising performing a fractional scaling of the plurality of coordinates associated with the original point cloud.

19. The method of claim 18, wherein performing the fractional scaling comprises:
passing a plurality of coordinates associated with the original point cloud through a fractional scaling block to generate a plurality of scaled coordinates associated with a scaled point cloud; and
encoding the plurality of scaled coordinates.

20. An apparatus comprising:
a processor; and
a memory storing instructions operative, when executed by the processor, to cause the apparatus to:
obtain a bitstream and an already-decoded set of coordinates;
generate a feature map by using the already-decoded set of coordinates;
use a neural network to produce one or more predicted displacements from each feature in the feature map; and
add the one or more predicted displacements to the already decoded set of coordinates to obtain a final reconstruction.
